(19) United States
(12) Patent Application Publication
(10) Pub. No.: US 2024/0045315 A1
(43) Pub. Date: Feb. 8, 2024

(54) PROJECTOR AND CONTROL METHOD THEREOF

(71) Applicant: SAMSUNG ELECTRONICS CO., LTD., Suwon-si (KR)

(72) Inventors: Junpyo KIM, Suwon-si (KR); Jeewon KIM, Suwon-si (KR); Sungil BANG, Suwon-si (KR)

(73) Assignee: SAMSUNG ELECTRONICS CO., LTD., Suwon-si (KR)

(21) Appl. No.: 18/215,582

(22) Filed: Jun. 28, 2023

Related U.S. Application Data
(63) Continuation of application No. PCT/KR23/06748, filed on May 18, 2023.

(30) Foreign Application Priority Data
Aug. 3, 2022 (KR) 10-2022-0096870

(51) Int. Cl. G03B 21/14

(52) U.S. Cl. CPC G03B 21/145

(57) ABSTRACT

A projector includes: a main body; an optical engine configured to project an image; a housing on which the optical engine is provided, the housing being movable to an inside area of the main body or to a front surface of the main body; a driving device configured to move the housing; and a processor configured to control the driving device based on an operation mode of the projector.

### CROSS-REFERENCE TO RELATED APPLICATION(S)

This application is a bypass continuation of International Application No. PCT/KR2023/006748, filed on May 18, 2023, in the Korean Intellectual Property Receiving Office, which is based on and claims priority to Korean Patent Application No. 10-2022-0096870, filed on Aug. 3, 2022, in the Korean Intellectual Property Office, the disclosures of which are incorporated by reference herein in their entireties.

### BACKGROUND

### 1. Field

The disclosure relates to a projector device, and more particularly, to a projector in which an optical engine of the projector device may move, and thus, a size of a screen may be adjusted without moving the projector device itself, and thus, the optical engine may be adjusted by a characteristic of a content or a user's intended manipulation.

### 2. Description of Related Art

An image or a photograph may be easily displayed in a computer or a cell phone, etc., but a projector device (or a beam projector) may be used for optically projecting and enlarging an image or a photograph. A projector may be used by being spaced apart from a screen (or a wall) by a sufficient distance. The projector may be used while maintaining the distance between the projector and a screen (or a wall) to be short. In a case of a projector that is used while maintaining the distance between the projector and the screen (or the wall) to be relatively short, the projector may be installed while keeping a distance from the projector to the screen (or the wall) for implementing the size of the screen that a user wants.

### SUMMARY

According to one or more embodiments, a projector includes: a main body; an optical engine configured to project an image; a housing on which the optical engine is provided, the housing being movable to an inside area of the main body or to a front surface of the main body; a driving device configured to move the housing; and a processor configured to control the driving device based on an operation mode of the projector.

According to one or more embodiments, a control method of a projector, the method includes: selecting a plurality of driving modes by a user; driving a driving device for moving a housing based on a driving mode selected by the user among the plurality of driving modes; moving the housing to a front surface of the projector by the driving device; and projecting an image to a direction of a upper surface or a direction of a rear surface of the projector in the front surface of the projector by an optical engine provided on the housing. The plurality of driving modes includes: a first mode in which a lens of the optical engine is exposed to an outside of a main body and the housing of the projector is moved to a direction of the front surface of the main body by a first distance; and a second mode in which the housing of the projector is moved to the direction of the front surface of the main body by a second distance that is longer than the first distance.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a perspective view of the front surface illustrating a case wherein a projector according to one or more embodiments of the disclosure is driven;

FIG. 1B is a perspective view of the front surface illustrating a case wherein a projector according to one or more embodiments of the disclosure is not driven;

FIG. 2 is a perspective view of the rear surface illustrating the internal components of a projector according to one or more embodiments of the disclosure;

FIG. 3A is a side surface diagram illustrating a first guide member of a projector according to one or more embodiments of the disclosure;

FIG. 3B is a side surface diagram illustrating a second guide member of a projector according to one or more embodiments of the disclosure;

FIG. 4A is a diagram illustrating a driving device of a projector according to one or more embodiments of the disclosure;

FIG. 4B is a diagram illustrating a driving device wherein the motor illustrated in FIG. 4A is provided as a plurality of motors;

FIG. 4C is a diagram illustrating a driving device of a projector according to one or more embodiments of the disclosure;

FIG. 5 is a block diagram illustrating a control process of a processor of a projector according to one or more embodiments of the disclosure; and

FIG. 6 is a block diagram illustrating a control method of a projector according to one or more embodiments of the disclosure.

### DETAILED DESCRIPTION

The embodiments described below are exemplary embodiments for promoting understanding of the disclosure, and it should be noted that the disclosure may be implemented while being modified in various forms, unlike the embodiments described herein. In explaining the disclosure below, in case it is determined that detailed explanation of related known functions or components may unnecessarily confuse the gist of the disclosure, the detailed explanation and detailed illustration will be omitted. Also, in the accompanying drawings, some components may not be illustrated according to their actual sizes but they may be illustrated in exaggerated sizes, for promoting understanding of the disclosure.

In addition, as terms used in this specification and the claims, general terms were selected in consideration of the functions described in the disclosure. However, the terms may vary depending on the intention of those skilled in the art who work in the pertinent field or legal or technical interpretation, and emergence of new technologies, etc. Also, there are some terms that were designated by the applicant on his own, and in such cases, the meaning of the terms may be interpreted as defined in this specification. If there is no specific definition of the terms, the meaning of the terms may be interpreted based on the overall content of this specification and technical knowledge common in the pertinent technical field.

Further, in this specification, expressions such as “have,” “may have,” “include,” and “may include” denote the existence of such characteristics (e.g.: elements such as numbers, functions, operations, and components), and do not exclude the existence of additional characteristics.

Also, terms such as “first,” “second,” and the like may be used to describe various elements, but it is not intended that the elements are limited by the terms. Such terms may be used only for the purpose of distinguishing one element from another element. For example, a first element may be called a second element, and a second element may be called a first element in a similar manner, without departing from the scope of the disclosure.

In addition, terms such as ‘the front surface,’ ‘the rear surface,’ ‘the upper surface,’ ‘the lower surface,’ ‘the side surface,’ ‘the left side,’ ‘the right side,’ ‘the upper part,’ ‘the lower part,’ etc. used in the disclosure were defined based on the drawings, and the shapes and locations of respective elements are not limited by these terms.

Also, in this specification, elements necessary for description of each embodiment of the disclosure were explained, and thus elements are not necessarily limited thereto. Accordingly, some elements may be modified or omitted, or other elements may be added. In addition, elements may be arranged while being dispersed to devices independent from one another.

Further, while the embodiments of the disclosure will be described in detail with reference to the following accompanying drawings and the content described in the accompanying drawings, it is not intended that the disclosure is restricted or limited by the embodiments.

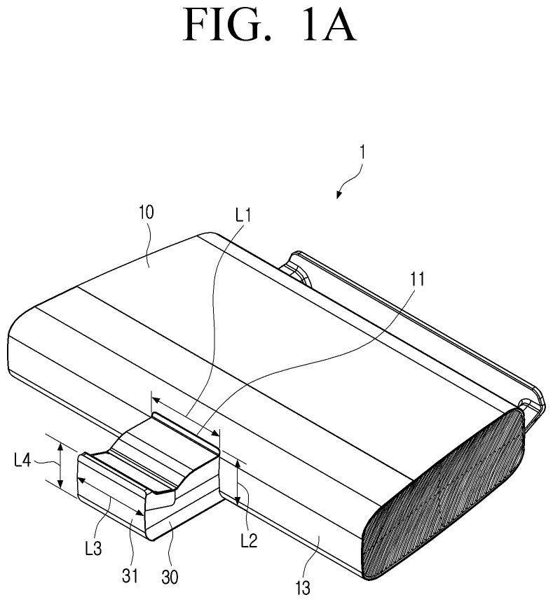

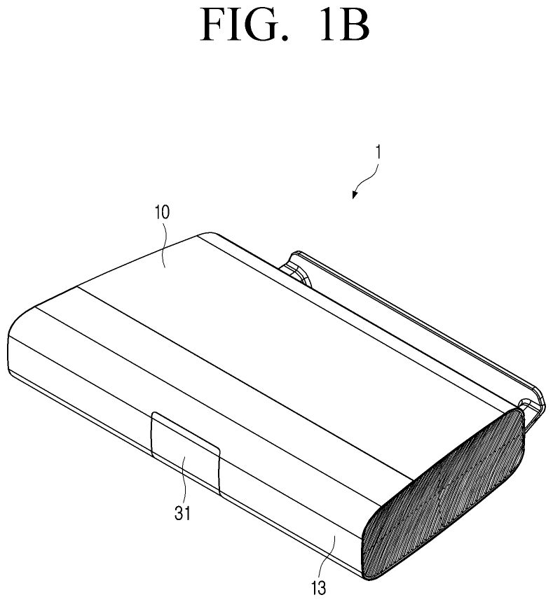

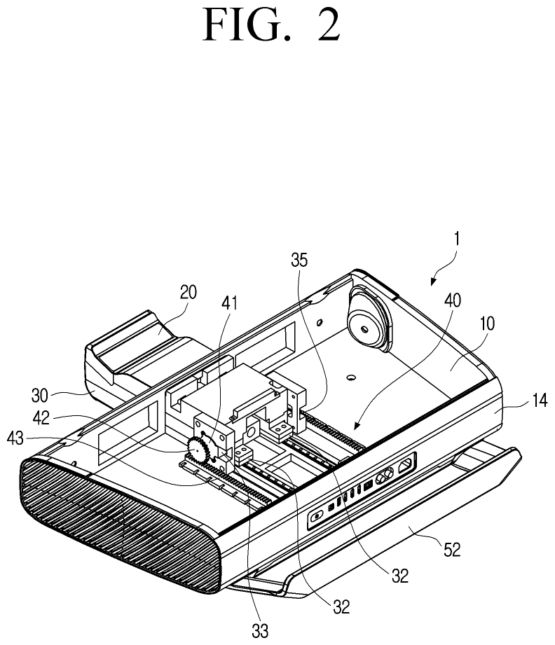

Hereinafter, the disclosure will be described in more detail with reference to FIG. 1A to FIG. 2.

FIG. 1A is a perspective view of the front surface illustrating a case wherein a projector according to one or more embodiments of the disclosure is driven, and FIG. 1B is a perspective view of the front surface illustrating a case wherein a projector according to one or more embodiments of the disclosure is not driven. FIG. 2 is a perspective view of the rear surface illustrating the internal components of a projector according to one or more embodiments of the disclosure.

The projector 1 is a device that implements an image by projecting light on a wall or a screen, etc. The projector 1 illustrated in FIG. 1A and FIG. 1B may, when in use, make the optical engine 20 projecting light protrude to the front surface 13 of the main body 10 and project a screen. When the projector 1 is not used, the projector 1 may (e.g., completely) house the housing 30 on which the optical engine 20 is provided inside the main body 10. As the optical engine 20 is provided on the housing 30 and protrudes to the front surface of the main body 10 and projects light, a wide space for installing the projector 1 is not needed. The size of the screen is adjusted as the housing 30 moves, and thus the size of the screen can be adjusted freely to fit the size of the wall surface or the screen, etc. used by the user, or a characteristic of a content. As the housing 30 may move for adjusting the screen, it is not necessary to move the projector 1 itself. Also, as the housing 30 can move separately, it is not necessary that a structure wherein the projector 1 is provided is excessively big, or the projector 1 is spaced a lot from the structure on which the screen is projected. In case the projector 1 is not used, the housing 30 is (e.g., completely) placed inside the main body 10, and thus there is an effect that spatial efficiency increases.

The projector 1 may include a main body 10, an optical engine 20, a housing 30, a driving device 40, and a processor 70.

The main body 10 may include a main groove 11. Through the main groove 11, the housing 30 may be exposed to the outside of the main body 10, or placed in the main body 10. The rear surface 14 of the main body 10 may include an electronic port part that can be connected to an external device.

The optical engine 20 may project an image. The optical engine may include a lens, a lamp (or a light emitting diode), a DMD (Digital Micro-mirror Device), a prism, a color wheel (or LCD panel), and aspheric mirror. When the optical engine 20 protrudes to a direction of the front surface of the main body 10, the optical engine 20 may project an image in a direction of the upper surface and/or a direction of the rear surface of the main body 10 in the front surface of the main body 10. The size of the projected image may vary correspondingly to the location of the optical engine 20. As the location of the optical engine 20 becomes farther from the main body 10, a bigger screen may be implemented. As the optical engine 20 needs to project an image in the direction of the rear surface direction of the main body 10, the part of the housing 30 on which the optical engine 20 is provided may be formed to be tilted in the direction of the rear surface of the main body 10 by a predetermined angle. The optical engine 20 is illustrated as a rectangular shape, but is not limited thereto, and its shape and size may be diverse.

On the housing 30, the optical engine 20 may be provided. The housing 30 may protrude in the direction of the front surface of the main body 10 of the projector 1 according to whether the projector 1 is used, and may be placed inside the main body 10. The part of the housing 30 on which the optical engine 20 is provided may be formed to be tilted in the direction of the rear surface of the main body 10. The horizontal width L3 of the front surface 31 of the housing 30 may be identical to the horizontal width L1 of the main groove 11. The horizontal width L1 of the main groove 11 may be wider than the horizontal width L3 of the front surface 31 of the housing 30 by a predetermined length. When the housing 30 is (e.g., completely) placed inside the main body 10, the front surface 31 of the housing 30 may be formed in an identical shape to the front surface 13 of the main body 10 such that the main body 10 and the front surface 31 of the housing 30 seem to be connected. The front surface 31 of the housing 30 and the front surface 13 of the main body 10 may have the same radius of curvature. Also, the front surface 31 of the housing 30 and the front surface 13 of the main body 10 may be manufactured with the same material. When the housing 30 is (e.g., completely) placed inside the main body 10, the vertical length L4 of the front surface 31 of the housing 30 may be formed to be identical to the vertical length L2 of the front surface 13 of the main body 10 such that the inside of the main body 10 is (e.g., completely) sealed. When the housing 30 is (e.g., completely) placed inside the main body 10, and the inside of the main body 10 is (e.g., completely) sealed, the optical engine 20 is also (e.g., completely) sealed, and in case the projector 1 is not used, the optical engine 20 can be protected from the dust or outside pollution. This can improve the performance of the optical engine 20 in case the projector 1 is used for a long time.

The driving device 40 may expose the housing 30 to the front surface 13 of the main body 10, or move the housing 30 such that it is (e.g., completely) placed inside the main body 10. The detailed configuration of the driving device 40 will be described later.

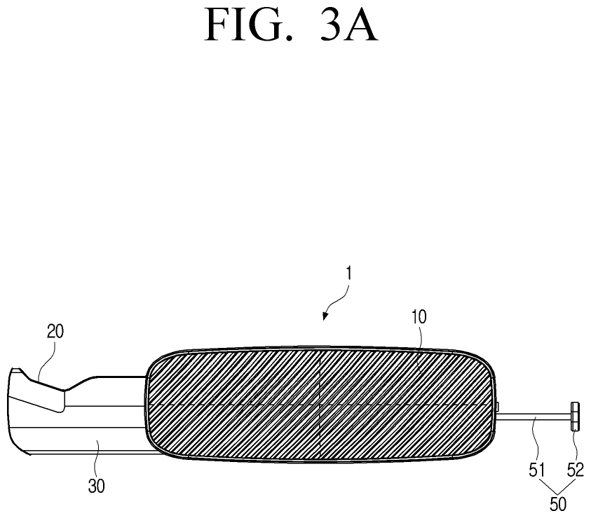

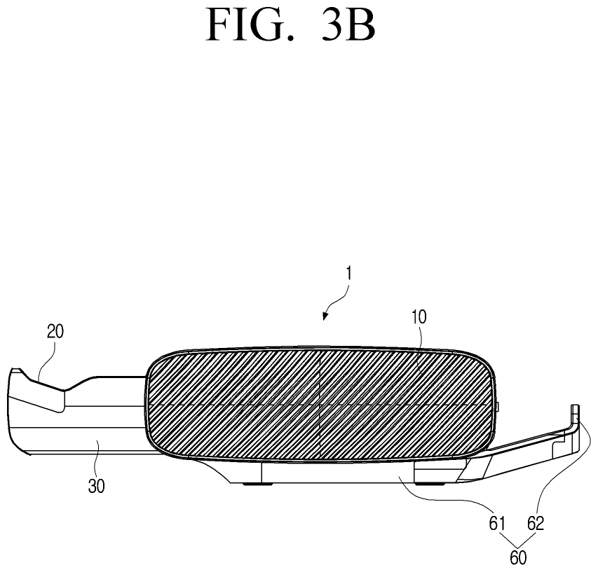

Hereinafter, guide members of the projector will be described in detail with reference to FIG. 3A and FIG. 3B.

FIG. 3A is a side surface diagram illustrating a first guide member of a projector according to one or more embodiments of the disclosure, and FIG. 3B is a side surface diagram illustrating a second guide member of a projector according to one or more embodiments of the disclosure.

The projector 1 may further include at least one of the first guide member 50 or the second guide member 60.

The first guide member 50 may be coupled with the rear surface 14 of the main body 10. Also, the first guide member 50 may have a length that protrudes by a predetermined distance. Further, the first guide member 50 may include a pair of first connection members 51 coupled with the rear surface 14 of the main body 10. Also, the first guide member 50 may include a first supporting member 52 of which one end and the other end are connected with the pair of first connection members 51, and which adjoins the wall on the rear surface 14 of the main body 10. As the first guide member 50 adheres to an external structure, the horizontality of the projector 1 on the left and right sides can be maintained.

The first connection members 51 may be coupled with the rear surface 14 of the main body 10. Also, the first connection members 51 may be coupled with both side surfaces of the main body 10. The pair of first connection members 51 may be formed to be in parallel to each other. The first connection members 51 may be connected to the bottom part of the port part on the rear surface of the main body 10. However, the pair of first connection members 51 is not limited to the illustrated shapes, and their shapes may be diverse.

The first supporting member 52 may include a plane which is perpendicular to the horizontal surface on which the main body 10 is provided. Also, both of one end and the other end of the first supporting member 52 may be connected with the first connection members 51.

The second guide member 60 may be coupled with the lower surface of the main body 10. Also, the second guide member 60 may have a length that protrudes toward the rear surface 14 of the main body 10 by a predetermined distance. In addition, the second guide member 60 may be extensively formed from the lower surface of the main body 10 toward the rear surface 14 of the main body 10. Further, the second guide member 60 may include a pair of second connection members 61 coupled with the lower surface of the main body 10. Also, the second guide member 60 may include a second supporting member 62 of which one end and the other end are connected with the pair of second connection members 61, and which adjoins the wall on the rear surface 14 of the main body 10.

The second connection members 61 may be coupled with the lower surface of the main body 10. The second connection members 61 may be coupled with the edge portions on the left and right sides of the lower surface of the main body 10. Also, the pair of second connection members 61 may be formed to be in parallel with each other. As the pair of second connection members 61 has the same thickness, the horizontality of the projector 1 can be adjusted.

The second supporting member 62 may include a plane which is perpendicular to the horizontal surface on which the main body 10 is provided.

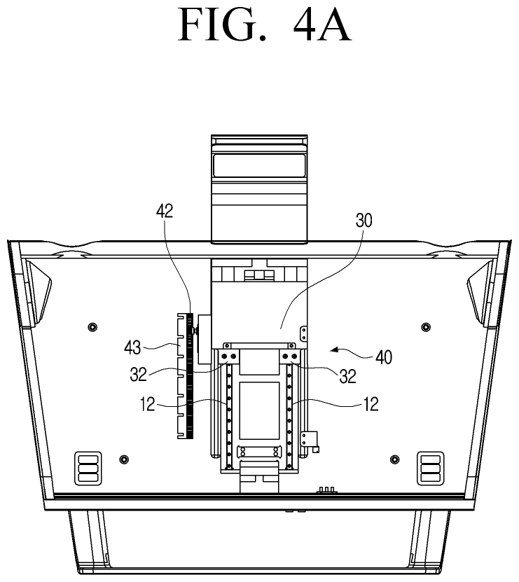

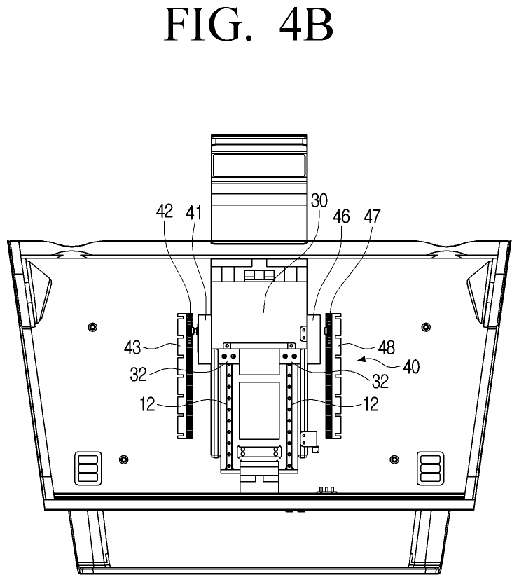

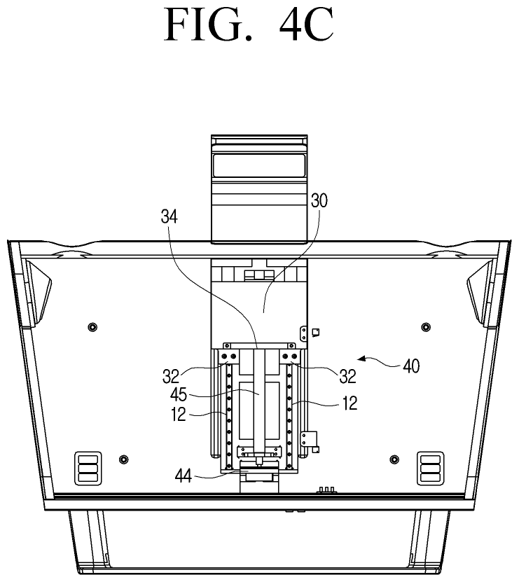

Hereinafter, the driving device of the projector will be described in more detail with reference to FIG. 4A to FIG. 4C.

FIG. 4A is a diagram illustrating a driving device of a projector according to one or more embodiments of the disclosure, and FIG. 4B is a diagram illustrating a driving device wherein the motor illustrated in FIG. 4A is provided as a plurality of motors. FIG. 4C is a diagram illustrating a driving device of a projector according to one or more embodiments of the disclosure.

The main body 10 of the projector 1 may further include a guide rail 12. The guide rail 12 may guide the housing 30 to move linearly. The housing 30 may further include a groove 32 which is formed along the longitudinal direction of the housing 30 on both sides of the lower surface of the housing 30, and can house the guide rail 12.

The guide rail 12 may be (e.g., completely) placed in the groove 32. The shape of the guide rail 12 may be diverse, and is not limited to the illustrated shape. The lengths of the guide rail 12 and the groove 32 may be identical.

Referring to FIG. 4A, the housing 30 may further include a first groove 33 formed on the side surface of the housing 30. The driving device 40 may include a first motor 41, a first gear 42, and a first rack gear 43.

The first motor 41 may be placed in the first groove 33, and drive the housing 30 such that the housing 30 protrudes to the front surface 13 or is (e.g., completely) placed in the main body 10. The first motor 41 may be controlled by the processor 70. The form of the first groove 33 may be formed correspondingly to the first motor 41. In FIG. 4A, it was illustrated that the first groove 33 is formed on the left side of the housing 30, but the disclosure is not limited thereto, and the first groove 33 may be formed on the right side. The shape of the first groove 33 is not limited to what is illustrated, but may be diverse.

The first gear 42 may be connected to the driving axis of the first motor 41. The first gear 42 may transmit the power of the first motor 41 to the first rack gear 43. The first rack gear 43 may be engaged with the first gear 42, and may be formed along the moving direction of the housing 30.

Referring to FIG. 4B, the housing 30 may further include the first groove 33, and the driving device 40 may include the first motor 41, the first gear 42, and the first rack gear 43. As the components are identical to the aforementioned components, detailed explanation will be omitted. The housing 30 may further include a third groove 35 formed on the side surface of the housing 30. The driving device 40 may further include a third motor 46, a third gear 47, and a third rack gear 48.

The third groove 35 may be formed on the opposite side surface of the first groove 33. In FIG. 4B, the third groove 35 is formed on the right side, and the first groove 33 is formed on the left side. However, the disclosure is not limited thereto, and the third groove 35 may be formed on the left side, and the first groove 33 may be formed on the right side.

The third motor 46 may be placed in the third groove 35, and drive the housing 30 such that the housing 30 protrudes to the front surface 13 or is (e.g., completely) placed in the main body 10. The third motor 46 may be controlled by the processor 70. The form of the third groove 35 may be formed correspondingly to the form of the third motor 46. However, the shape of the third groove 35 is not limited to what is illustrated, but may be diverse.

The third gear 47 may be connected to the driving axis of the third motor 46. The third gear 47 may transmit the power of the third motor 46 to the third rack gear 48. The third rack gear 48 may be engaged with the third gear 47, and may be formed along the moving direction of the housing 30.

Referring to FIG. 4C, the housing 30 may further include a second groove 34, and the driving device 40 may further include a second motor 44 and a rotation axis 45.

The second groove 34 may be connected with the driving device 40 on the rear surface of the housing 30.

The second motor 44 may drive the housing 30 such that the housing 30 protrudes to the front surface 13 or is (e.g., completely) placed in the main body 10.

The rotation axis 45 may convert a rotation movement of the second motor 44 into a linear movement of the housing 30. When power is transmitted by the second motor 44, the rotation axis 45 may rotate, and the housing 30 may move by the second groove 34 connected with the rotation axis 45.

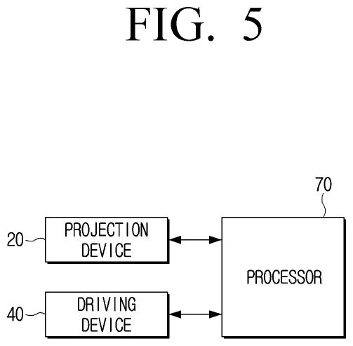

Hereinafter, a control process of the processor of the projector according to the disclosure will be described in detail with reference to FIG. 5.

FIG. 5 is a block diagram illustrating a control process of a processor of a projector according to one or more embodiments of the disclosure.

The processor 70 controls the overall operations of the projector 1. In particular, the processor 70 may not only be implemented as one processor 70, but may also be implemented as a plurality of processors 70.

The processor 70 may be implemented in various methods. For example, the processor 70 may be implemented as at least one of an application specific integrated circuit (ASIC), an embedded processor, a microprocessor, a hardware control logic, a hardware finite state machine (FSM), or a digital signal processor (DSP).

In the disclosure, the processor 70 may include one or more of a central processing unit (CPU) processing digital signals, a micro controller unit (MCU), a micro processing unit (MPU), a controller, an application processor (AP), or a communication processor (CP), and an ARM processor, or may be defined by the terms. Also, the processor 70 may be implemented as a system on chip (SoC) having a processing algorithm stored therein or large scale integration (LSI), or in the form of a field programmable gate array (FPGA). The processor 70 may perform various functions by executing computer executable instructions stored in the memory. In addition, for performing an artificial intelligence function, the processor 70 may include at least one of a graphics-processing unit (GPU), a neural processing unit (NPU), or a visual processing unit (VPU), which are separate AI-dedicated processors.

The processor 70 may drive the operation system or an application program and control hardware or software components connected to the processor 70, and perform various kinds of data processing and operations. Also, the processor 70 may load an instruction or data received from at least one of other components on a volatile memory and process them, and store various data in a non-volatile memory.

A detailed control method of the projector 1 of the processor 70 will be described in detail with reference to FIG. 5.

The processor 70 may control the driving device 40 such that the optical engine 20 is located in a location corresponding to the operation mode of the projector 1. The operation mode may include a first mode wherein the lens of the optical engine 20 is (e.g., completely) exposed to the outside and the housing 30 is spaced in the direction of the front surface of the main body 10 by a first distance. Also, the operation mode may include a second mode wherein the housing 30 is spaced by a second distance which is more spaced than the first distance in the direction of the front surface of the main body 10.

The processor 70 may correct a layout of an image correspondingly to the location of the optical engine 20, and control the optical engine 20 such that the corrected image is projected. As the projector 1 projects an image in the direction of the upper surface of the main body 10, in case an image is projected as it is, the image may be projected on a screen or a wall, etc. in a form wherein its upper end became wider and its lower end is relatively narrow. For complementing this, the processor 70 may perform a correction of distorting the image correspondingly to the location of the optical engine 20.

The processor 70 may control the driving device 40 such that the optical engine 20 is located in a location corresponding to a screen ratio of an image. An appropriate screen ratio exists according to a type of an image, and the processor 70 may control the driving device 40 for implementing an appropriate screen ratio in accordance thereto. For example, in the case of using a personalized content such as personal broadcasting like Internet broadcasting, the screen may be adjusted to a more appropriate size than a large screen, and in the case of a vertical screen content, the screen may be adjusted such that the vertical length is projected to be longer than the horizontal length.

The processor 70 may control the driving device 40 such that the optical engine 20 is located in a location randomly designated by the user. Although an appropriate screen ration exists according to a characteristic of an image, the ratio or the size of the screen can be adjusted according to the user's preference.

The processor 70 may receive information on an area to which a screen is projected from a plurality of sensors. In case a screen is projected on a wall surface, the plurality of sensors may recognize the ceiling, and control the driving device 40 such that an image is projected only on the wall surface without being extended to the ceiling. The plurality of sensors may include an infrared sensor.

Hereinafter, a control method of a projector according to the disclosure will be

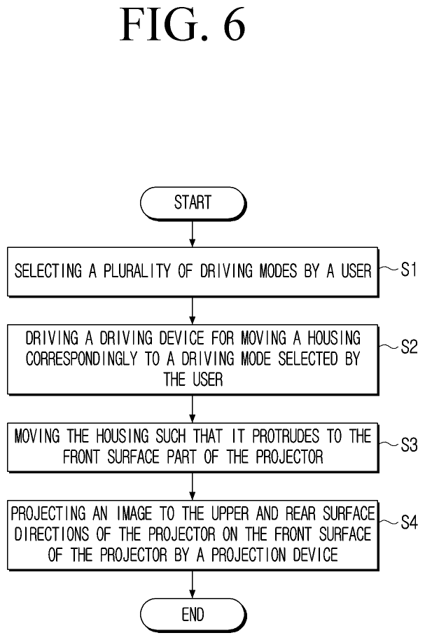

described in detail with reference to FIG. 6.

FIG. 6 is a block diagram illustrating a control method of a projector according to one or more embodiments of the disclosure.

A control method of the projector 1 may include operations of selecting a plurality of driving modes by a user (S1), driving the driving device 40 for moving the housing 30 correspondingly to a driving mode selected by the user among the plurality of driving modes (S2), moving the housing 30 such that it protrudes to the front surface 13 of the main body of the projector 1 by the driving device 40 (S3), and projecting an image to the direction of the upper surface and the direction of the rear surface of the projector 1 on the front surface of the projector 1 by the optical engine 20 provided on the housing 30 (S4). The operation of selecting a plurality of driving modes by a user may include receiving input of the user's selection signal for one of the plurality of driving modes by the projector 1. Also, the operation of driving the driving device 40 includes an operation of the driving device of driving a motor, etc., and making various kinds of axes or gears, etc. connected with the motor move.

The plurality of driving modes may include a first mode wherein a lens of the optical engine 20 is (e.g., completely) exposed to the outside and the housing 30 is spaced in the direction of the front surface of the main body 10 by a first distance, and a second mode wherein the housing 30 is spaced by a second distance which is more spaced than the first distance.

Also, in case the user drove the projector 1 without selecting the driving mode, the projector 1 may be controlled to operate in the driving mode that the user finally set.

The plurality of driving modes may include a manual mode wherein the user can randomly adjust the location of the optical engine 20. In the manual mode, the user may transmit a signal to the projector 1 through a remote device, etc., and thereby adjust the location of the optical engine 20. However, a method for the user to transmit a signal is not limited to the method through a remote device, and there may be various methods of transmitting a signal.

While preferred embodiments of the disclosure have been shown and described, the disclosure is not limited to the aforementioned specific embodiments, and it is apparent that various modifications can be made by those having ordinary skill in the art to which the disclosure belongs, without departing from the gist of the disclosure as claimed by the appended claims, and such modifications are within the scope of the descriptions of the claims.

What is claimed is:

1. A projector comprising:
a main body;
an optical engine configured to project an image;
a housing on which the optical engine is provided, the housing being movable to an inside area of the main body or to a front surface of the main body;
a driving device configured to move the housing; and
a processor configured to control the driving device based on an operation mode of the projector.

2. The projector of claim 1, wherein the optical engine is further configured to project the image to at least one direction in the front surface of the main body.

3. The projector of claim 2, wherein the at least one direction corresponds to a direction of an upper surface of the main body or to a direction of a rear surface of the main body.

4. The projector of claim 1, wherein the operation mode comprises:
a first mode in which a lens of the optical engine is exposed to an outside of the main body and the housing protrudes to a direction of the front surface of the main body by a first distance; and
a second mode in which the housing protrudes to the direction of the front surface of the main body by a second distance, the second distance being longer than the first distance.

5. The projector of claim 4, wherein the processor is further configured to adjust a layout of the image based on a location of the optical engine, the location of the optical engine being controlled by the processor.

6. The projector of claim 1, wherein the processor is further configured to control the driving device to locate the optical engine in a location corresponding to a screen ratio of the image.

7. The projector of claim 1, wherein the processor is further configured to control the driving device to located the optical engine in a location designated by a user.

8. The projector of claim 1, wherein the main body further comprises a main groove configured to guide the housing being movable to the front surface of the main body,
wherein a horizontal width of the front surface of the housing is substantially identical or identical to a horizontal width of the main groove,
wherein, based on the housing being placed in the inside area of the main body, a front surface of the housing is formed in an identical shape to the front surface of the main body, and
wherein the front surface of the main body and the front surface of the housing are connected.

9. The projector of claim 8, wherein, based on the housing being placed in the inside area of the main body, a vertical length of the front surface of the housing is substantially identical or identical to a vertical length of the front surface of the main body, and
wherein the inside area of the main body is sealed.

10. The projector of claim 1, further comprising:
a first guide member coupled with a rear surface of the main body, the first guide member having a length protruding by a first predetermined distance,
wherein the first guide member comprises:
a pair of first connection members coupled with the rear surface of the main body; and
a first supporting member.

11. The projector of claim 10, wherein one end and the other end of the first support member are respectively connected with the pair of first connection members.

12. The projector of claim 10, wherein the first supporting member comprises a plane that is perpendicular to a horizontal surface on which the main body is provided.

13. The projector of claim 10, further comprising:
a second guide member coupled with a lower surface of the main body, the second guide member having a length protruding to a rear surface of the main body by a second predetermined distance,
wherein the second guide member comprises:
a pair of second connection members coupled with the lower surface of the main body; and
a second supporting member.

14. The projector of claim 13, wherein one end and the other end of the second supporting member are respectively connected with the pair of second connection members.

15. The projector of claim 14, wherein the second supporting member adjoins a wall on the rear surface of the main body.

16. The projector of claim 13, wherein the second supporting member comprises a plane that is perpendicular to a horizontal surface on which the main body is provided.

17. The projector of claim 1, wherein the main body comprises a guide rail configured to guide the housing to move linearly,
wherein the housing further comprises a groove formed along a longitudinal direction of the housing on a lower surface of the housing.

18. The projector of claim 17, wherein the housing further comprises a first groove formed on a side surface of the housing, and
wherein the driving device comprises:
a first motor placed in the first groove and configured to drive the housing;
a first gear connected to a driving axis of the first motor; and
a first rack gear engaged with the first gear, the first rack gear being formed along a moving direction of the housing.

19. The projector of claim 17, wherein the housing further comprises a second groove connected with the driving device on a rear surface of the housing, and
wherein the driving device comprises:
a second motor configured to drive the housing; and
a rotation axis of which one end is coupled with the second groove and the other end is connected with the second motor, and
wherein the rotation axis is configured to convert a rotation movement of the second motor into a linear movement of the housing.

20. A control method of a projector, the method comprising:
selecting a plurality of driving modes by a user;
driving a driving device for moving a housing based on a driving mode selected by the user among the plurality of driving modes;
moving the housing to a front surface of the projector by the driving device; and
projecting an image to a direction of a upper surface or a direction of a rear surface of the projector in the front surface of the projector by an optical engine provided on the housing,
wherein the plurality of driving modes comprises:
a first mode in which a lens of the optical engine is exposed to an outside of a main body and the housing of the projector is moved to a direction of the front surface of the main body by a first distance; and
a second mode in which the housing of the projector is moved to the direction of the front surface of the main body by a second distance that is longer than the first distance.
